(19) United States
(12) Patent Application Publication
(10) Pub. No.: US 2003/0115474 A1
(43) Pub. Date: Jun. 19, 2003

(54) System and method for validating the identity of a camera used in secure access applications employing biometrics

(76) Inventors: Sal Khan, Greely (CA); Martin D. Levine, Westmount (CA); Shahid Khan, Islamabad (PK)

Correspondence Address: GARDNER GROFF, P.C., PAPER MILL VILLAGE, BUILDING 23, 600 VILLAGE TRACE, SUITE 300, MARIETTA, GA, 30067, US

(21) Appl. No.: 10/161,065

(22) Filed: May 29, 2002

Related U.S. Application Data
(60) Provisional application No. 60/297,055, filed on Jun. 11, 2001.

(51) Int. Cl. H04K 1/00

(52) U.S. Cl. 713/186

(57) ABSTRACT

A challenge response system is disclosed for validating the identity of a camera used in a secure access application employing biometrics and attached to a workstation. The system includes a first identification means for identifying the camera; a second identification means for identifying the micro controller within the camera; and, means for authenticating the identity of the camera attached to the workstation. The identification means are one of a string of numbers, letters or an alphanumeric string of a predetermined length sufficient to provide a unique identifier. When an authorized camera is attached to the workstation the identification means are transmitted to and stored on the workstation. When the user desires access to the workstation the workstation will challenge the camera for identification means. If the response does not match the means stored in the workstation access is denied.

### CROSS-REFERENCE TO RELATED APPLICATIONS

This application claims the benefit of U.S. Provisional Patent Application Serial No. 60/297,055 filed in the United States Patent and Trademark Office on Jun. 5, 2001, which is hereby incorporated herein by reference in its entirety for all purposes.

### FIELD OF THE INVENTION

The present invention relates to a system and method for validating the identity of a remote part in secure access applications and more specifically is concerned with a system and method for validating the identity of a video camera used in secure access applications employing biometrics.

### BACKGROUND OF THE INVENTION

Digital video cameras and biometrics can be used for restricted area access control, time and attendance recording and computer network access control, video surveillance and other applications requiring personal identification to access entitlements, benefits or a service. These applications are known as “secure access” applications and shall be referred to in that manner throughout this document. One such camera is described in U.S. Patent Application No. 60/289,635 filed by the same inventors on May 9, 2001.

In many situations, such as access to sensitive government installations or financial institutions, a very high degree of certainty is required in ascertaining the true identity of the authorized person. While the use of biometrics in such applications offers many benefits, a problem still remains with respect to the vulnerability of such systems to counterfeit devices and interception of video signals. Prior art apparatus and methodologies for secure data transmission are represented by U.S. Letters Patent No. 6,226,748 granted on May 1, 2001; U.S. Letters Patent No. 6,223,292 granted on Apr. 24, 2001; U.S. Letters Patent No. 6,219,794 granted on Apr. 17, 2001; and, U.S. Letters Patent No. 6,189,098 granted on Jan. 9, 2001. Some of the prior art teaches various protocols and architecture for establishing secure virtual private networks enabling the transmission of secure data over a public network such as the Internet. While the prior art offers a degree of security of data transmission there still remains the problem of being able to authenticate that the camera being used to gain access to the restricted space is not counterfeit or that the signal being transmitted has not been intercepted and compromised prior to transmission over the public network. Another problem associated with the prior art is the need for a powerful microprocessor to perform the computations necessary for strong encryption. Such microprocessors cannot be integrated into video cameras without a significant increase in cost. The prior art also teaches the use of security tokens and card readers to authenticate the identity of an authorized person or authorized remote device prior to the transmission of secure data over a public or private network. These devices require the use of a personal identification number or key that must be manually inputted into the system. This acts as a disincentive to their use. Furthermore, the use of the tokens and smart cards creates additional problems in that they require the use of additional devices that must be carried by the authorized user. Some of these devices are battery operated and therefore require periodic maintenance or replacement when the battery is depleted. Tokens and smart cards can be lost or stolen. While prior art devices and methodologies using tokens, smart cards and encryption do provide for additional data security in certain applications, their use is not appropriate in the context secure access systems using digital video cameras and biometrics where low powered micro controllers and simplicity of use are required.

Hence, the disadvantages and limitations associated with the prior art apparatus and methodologies relate to the fact that they are not satisfactory in secure access systems using a video camera and biometrics, as they cannot prevent the use of counterfeit cameras or the interception and compromise of secure data being transmitted through such a secure access system.

Secure access applications using digital video cameras and biometrics require a system and method that are capable of providing the necessary degree of confidence that a request for access to a secure area originates from an authorized device and that the data transmitted during the request has not been intercepted and compromised. The apparatus and methodologies must be inexpensive to implement, simple to use by authorized persons and secure access system administrators and require a minimum of computational power.

### SUMMARY OF THE INVENTION

An object of the present invention is to provide an improved system and method for secure access using a video camera and biometrics that overcome the deficiencies of the prior art patents. The present invention overcomes the deficiencies of the prior art apparatus by offering a system and method for validating the identity of a remote part in secure access applications that uses a combination of low and high security features in a layered manner. The present invention takes advantage of the low computing power of micro controllers installed in the camera and is simple to use by system administrators and users alike.

In one embodiment, the present invention is to be used in a secure access system employing biometric security features to enhance the security of that secure access system and make it more difficult for hackers to gain access to the secure space by using counterfeit devices and signals. The secure space may be a virtual space, for example, access to a computer network, or it may be a real space, for example, access to a restricted physical space such as a room or building. A secure access system employing biometric security systems features a central authority, a person seeking access to the secured area, a camera with an image detector, a micro controller and a camera casing. The camera is to be attached to the workstation. The workstation may be a notebook computer, a desktop computer, a cellular telephone, a personal computing device or some other analogous device. The workstation generally comprises a microprocessor and memory. Software is installed in the workstation to receive and process the biometric data generated by the camera. In operation, the camera obtains a facial image of a person seeking secure access to the restricted area and transmits that image to the micro controller. The micro controller generates a video signal and transmits that signal to the workstation microprocessor to which access is desired. The software will convert the video signal to a biometric template. Subsequently, the software will compare the biometric template of the person requesting secure access to a plurality of biometric images stored on the workstation. If the software finds a match between the person requesting access and the authorized user, access to the workstation will be permitted. If there is no match, access will be denied.

In one embodiment of the present invention, a first identification number is permanently assigned to the camera and permanently etched onto the outside of the camera casing. The first identification number is generally installed during camera manufacture and is unique to a specific camera. The first identification number is recorded into the micro controller and is also visible to the central authority. The central authority enrols a person authorized for secure access using biometric security features of the secure access system. The central authority assigns the camera to the authorized person for a particular workstation. There may be a plurality of authorized persons for a single camera. A second invisible identification number is permanently recorded into the micro controller during manufacture of the micro controller. Only the micro controller knows the second identification number. The central authority will record the first identification number and correlate that number to the individual(s) to which the camera has been assigned, the identification of the workstation and the location of the workstation: for example, camera #456123789 has been assigned to authorized users Sal Khan, Martine Levine and Sahid Khan for use on portable note book computer serial number A2345698919939 for remote access applications.

Camera driver software and biometric processing software may have been previously installed on the workstation or it may be installed when the authorized person attaches the camera to the workstation. One advantageous feature of the present invention is that the authorized person can install the camera and the software on the workstation without assistance from the central authority. Once the camera is attached to the workstation, the workstation central processing unit senses the connection of the camera micro controller as a peripheral device. To initialize the set up between the camera and the workstation, a camera driver software on the workstation will query the camera micro controller for the first and second identification numbers. The micro controller will respond by transmitting the first and second identification numbers to the workstation. The first and second identification numbers will be stored in the workstation memory in a secure fashion. Afterwards, each time the authorized person seeks access to the secure system, the workstation will authenticate the identity of the camera by challenging the camera for the first and second identification numbers. Upon receipt of the response from the camera the camera driver on the workstation will compare the first and second identification numbers received from the camera with the first and second identification numbers stored on the workstation. If there is a match the camera will be enabled and biometric verification of the authorized person will be permitted. If there is no match, the camera will be disabled. In this way a counterfeit camera cannot be installed on the workstation to gain access to a secure space.

In another embodiment of the present invention, the first and second identification numbers will be stored in the micro controller and in the workstation in a secure fashion. A challenge response mechanism unique to each exchange between the micro controller and the workstation is included. Each time the authorized person seeks access to the secure system, the workstation will authenticate the identity of the camera by asking the camera for the first and second identification numbers. When the camera receives the query it will initiate the challenge response mechanism to protect the exchange of information between the camera and the workstation. The camera receives the response to the challenge from the workstation and compares the received response with an expected response. If there is a match, then the workstation will be provided the first and second identification numbers.

There may be situations where an unauthorized person attempts to assemble a set of possible challenges and responses. To prevent an unauthorized person from obtaining a possible set of challenges, there is provided another embodiment of the present invention in which an algorithm is installed on the micro controller to implement a timer set to a pre-programmed time during which invalid responses are sent to the workstation. If the micro controller receives an invalid challenge the timer starts and all challenges received during that time period are considered to be invalid. Invalid responses are then sent to the workstation during that time. The time can vary depending on the camera model, camera serial number or camera batch number. In this manner, an unauthorized person will be frustrated in attempting to obtain a set of possible challenges.

To prevent an unauthorized person from obtaining a possible set of responses there is provided yet another embodiment of the present invention wherein if the workstation receives an invalid response to a challenge, a timer is started by the camera driver software installed on the workstation that disables the device and delays further attempts to gain access. A number of retries may be allowed. The central authority may set the number of retries. In this way, the unauthorized person to obtain a possible correct response must expend an impossible amount of time. This embodiment of the present invention will also prevent attacks whereby an unauthorized person installs a counterfeit device between the camera and the workstation to record the challenge and response exchanges between the two devices.

In yet another embodiment of the present invention access to a remote server is desired. The camera is connected to a workstation and a remote server is connected to the workstation. The remote server includes a central processing unit and a memory. In this embodiment of the present invention, the first and second identification numbers are transmitted to the workstation and stored on the workstation memory. The first and second identification numbers are also transmitted to the server and stored on the server memory. The server will also verify the identity of the camera by seeking the first and second identification numbers stored in the micro controller. If there is a match the authorized user will be allowed to log on to the network.

### BRIEF DESCRIPTION OF DRAWINGS

The present invention will be further understood from the following description with references to the drawings in which:

FIG. 1 shows a typical camera and workstation.

FIG. 2 shows the spatial relationship between the authorized user and the workstation.

FIG. 3 shows the camera connected to the workstation.

FIG. 4 shows one embodiment of the present invention.

FIG. 5 shows another embodiment of the present invention.

FIG. 6 shows one embodiment of the present invention with time delay.

FIG. 7 shows another embodiment of the present invention.

FIG. 8 shows one embodiment of the present invention in a remote server application.

### DETAILED DESCRIPTION

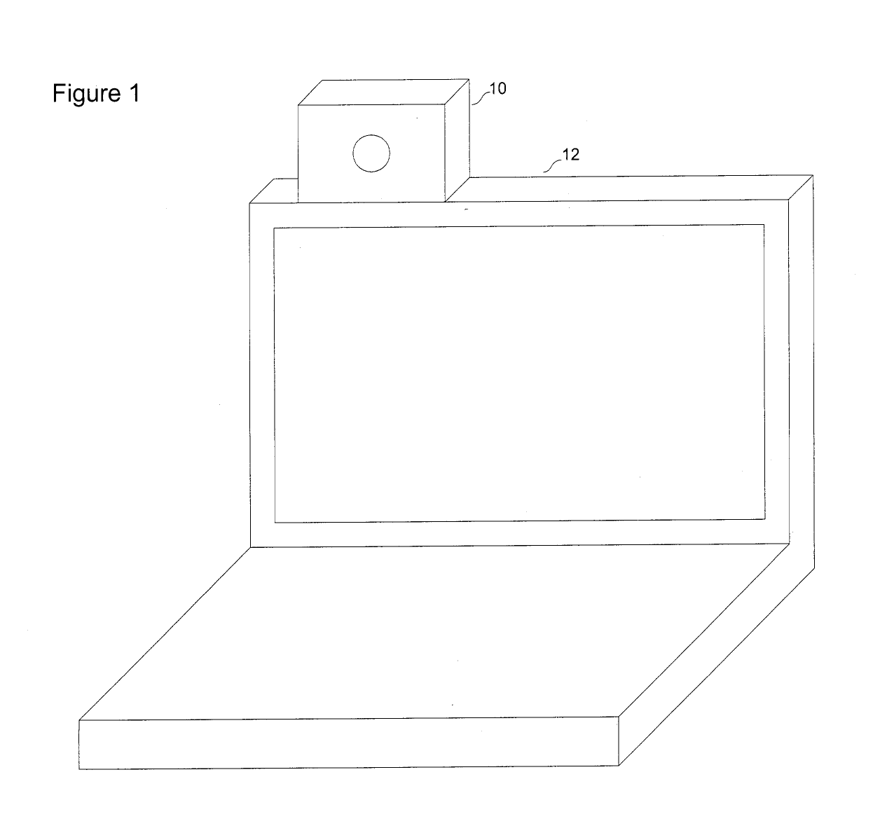

Referring to FIG. 1, there is shown a typical installation of a digital video camera (10) attached to a workstation (12). As shown in FIG. 1 workstation is a personal notebook computer. However, the workstation may also be a desktop computer or a personal computing device such as a PalmPilot® or a mobile phone or some other analogous device. The camera would be scaled to suit the application.

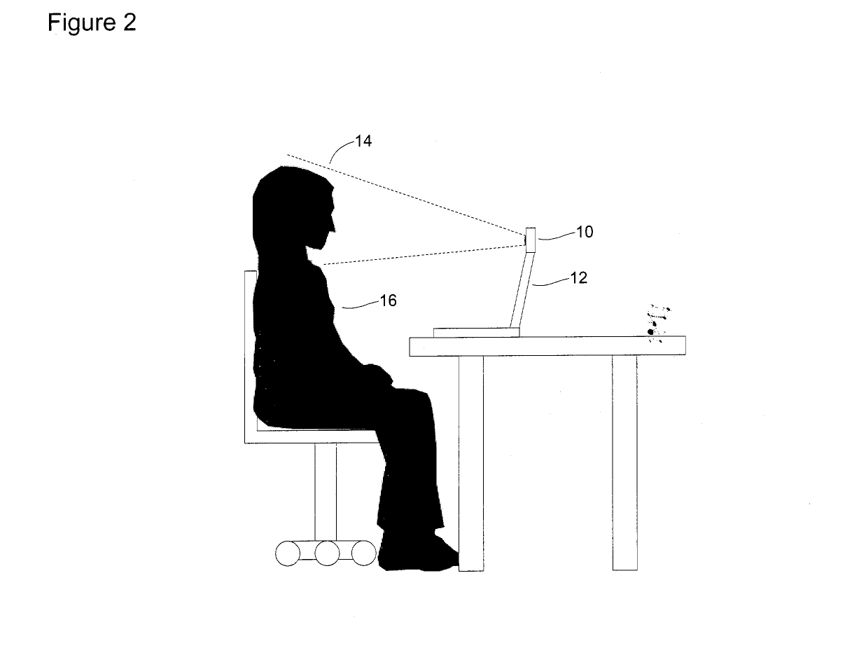

Shown in FIG. 2 is a typical installation of camera (10) mounted on workstation (12). In this embodiment of the present invention, the secure access system relies upon the capture of an accurate facial image (14) of authorized user (16). The camera may be affixed to the top of the workstation as in the case of a note book computer as shown in FIG. 2 or it may be affixed to some other portion of the work station that affords a clear view of the authorized user's face.

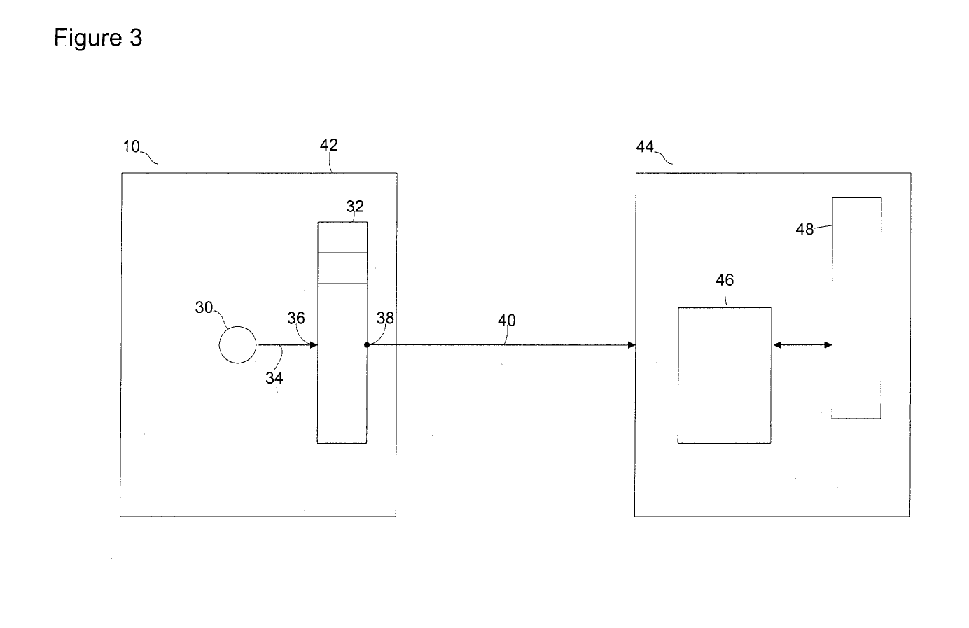

Referring to FIG. 3, there is shown a digital video camera (10) used for secure access applications as contemplated by the present invention. The camera (10) comprises a detector (30) that is connected to a micro controller (32). The micro controller is a video digital signal processor. Detector (30) is a complementary metal-oxide semi conductor sensor (CMOS) having a YUV output (34). Detector (30) is connected to the micro controller (32) from the YUV output (34) of the detector to the left input (36) of micro controller (32). Micro controller converts the digital signal received by the detector and generates a video signal (40). The detector (30) and the micro controller (32) are housed in casing (42). The casing may be attached to the workstation as shown in FIG. 1.

Still referring to FIG. 3, the camera is connected to a workstation by means of the video output bus (40). The workstation includes a central processing unit (46) and a memory device (48). FIG. 3 underscores the vulnerabilities associated with such an installation. Even if camera (10) were removed from the workstation (44), a counterfeit camera could be connected to the workstation and unauthorized access to the secure area could be obtained. A further weakness relates to video signal bus (40) that could be intercepted and a counterfeit signal transmitted to the workstation to gain unauthorized access.

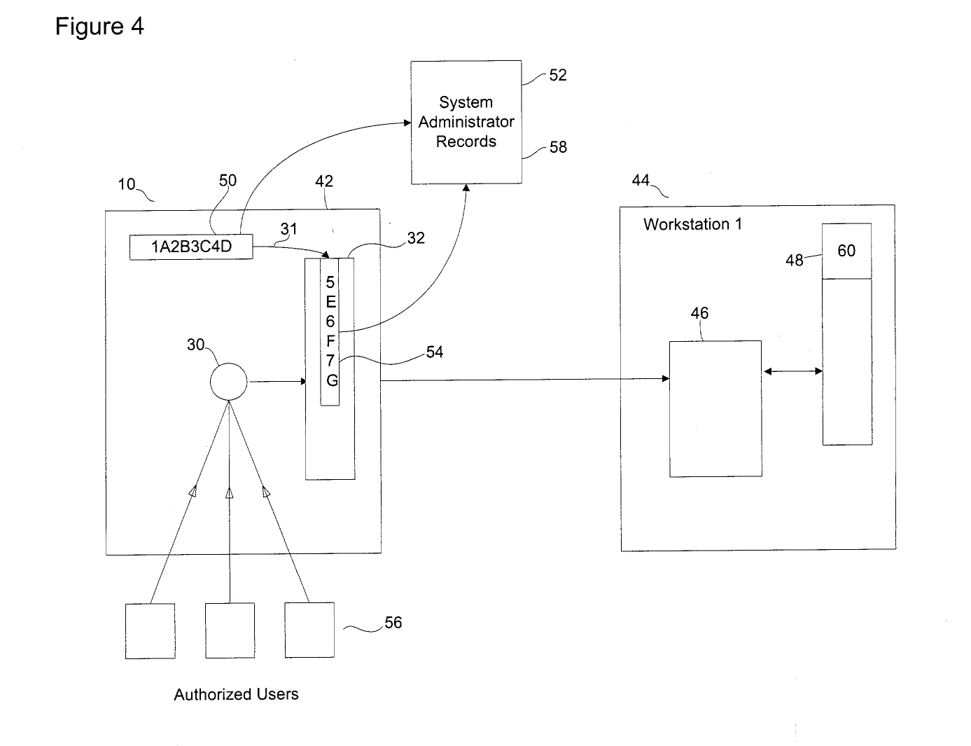

Referring to FIG. 4 there is shown one embodiment of the present invention that overcomes the security vulnerabilities identified above. FIG. 4 shows a camera (10) including a detector (30), a micro controller (32) and a camera casing (42). The casing houses the micro controller in such a way that removal of the micro controller is not possible without rendering it inoperable or alternatively incapable of being reversed engineered. During manufacturing of the camera, a first identification number (50) is permanently assigned to the camera casing and permanently etched into the outside of the camera casing (42). The identification number (50) may be a sequence of numbers or letters or an alphanumeric sequence of a suitable length. The identification number (50) is visible to a central authority (52) and permanently recorded (31) into the micro controller (32) during camera assembly. The central authority will assign the camera to an authorized person (56) on a particular workstation. There may be a plurality of authorized users (56) authorized to access a secure system using a single camera (10). A biometric template of each authorized user will be obtained in an enrolment process and stored in workstation memory (48) and processed by camera driver software (60). The system requires that the central authority (52) record (58) the identity of authorized users against the first identification number as well as the location of the workstation (44). This is also done for inventory purposes. A second invisible identification number (54) is permanently recorded into the micro controller during manufacture of the micro controller (32). The second identification number is unique to the micro controller. The second identification number (54) is known only to the micro controller and not to the central authority. The second identification number may be a sequence of numbers or letters or an alphanumeric sequence of a suitable length.

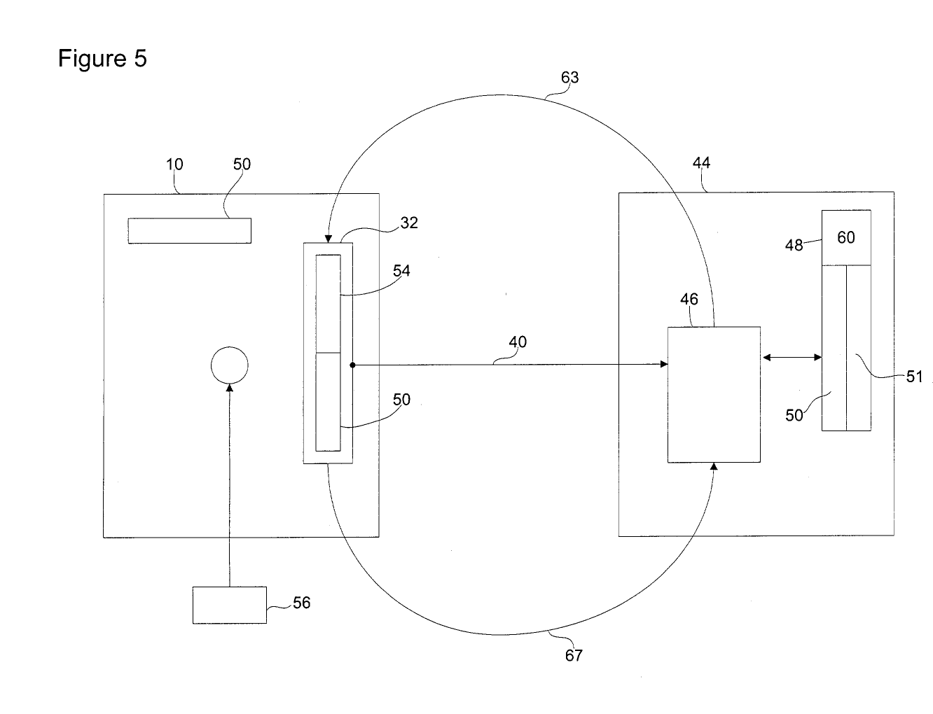

Referring to FIG. 5, camera (10) is attached to the workstation (44) by means of bus (40). Camera driver software (60) is loaded into the workstation memory (48). Once the workstation central processing unit (46) senses the connection of the camera micro controller (32) as a peripheral device, there is a camera initialization step whereby camera driver software (60) will query micro processor (32) for the first (50) and second (54) identification numbers. During initialization, the first and second identification numbers will be transmitted to the workstation and stored in a secure section of memory (48). Afterwards, each time the authorized person (56) seeks access to the secure system; the workstation will query the camera (63) for the first and second identification numbers. Upon receipt of the response (67) from the camera the camera driver on the workstation will compare the first and second identification numbers received from the camera with the first and second identification numbers stored on the workstation. If there is a match the camera will be enabled and biometric verification of the authorized person will be permitted. If there is no match, a configured number of retries will be allowed. If after the retries a match is not successful the camera will be disabled. In this way a counterfeit camera cannot be installed on the workstation to gain access to a secure space.

The operation of the system of the present invention is shown below in block diagram format in Block Diagram #1.

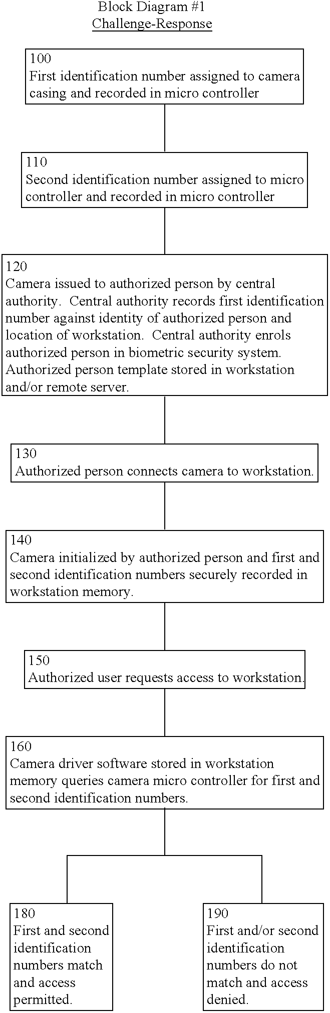

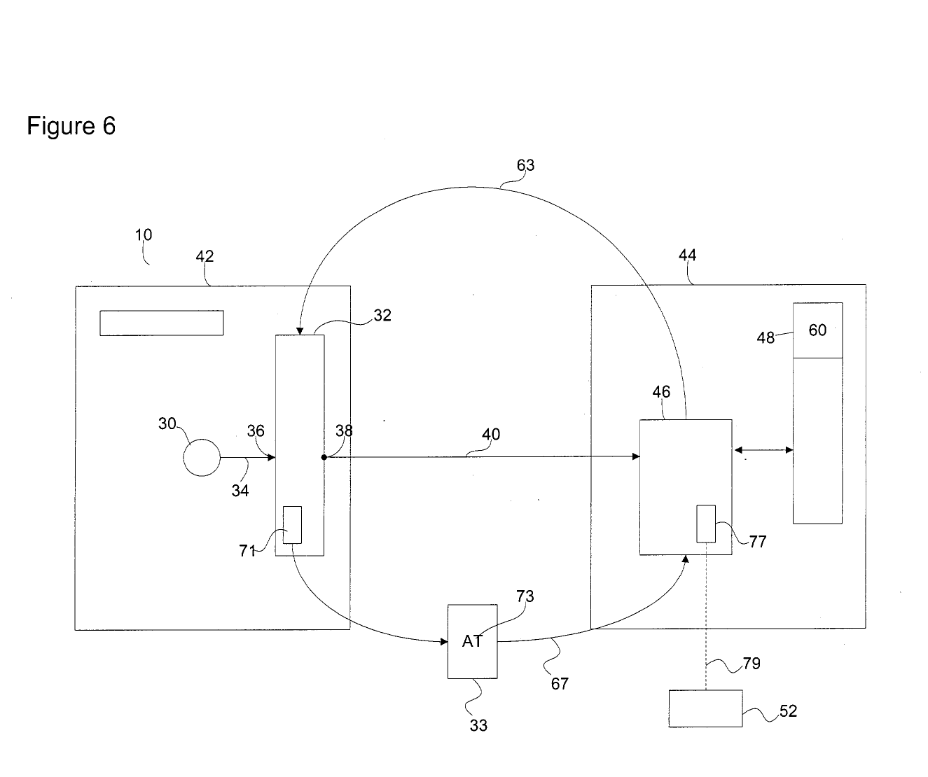

Referring to FIG. 6 there is another embodiment of the invention in which a challenge response mechanism is employed to ensure that the exchange of the first and second identification numbers between the camera and the workstation is secure. The first and second identification numbers are stored in the micro controller and in the workstation in a secure fashion. A challenge response mechanism unique to each exchange between the micro controller and the workstation is included. Each time the authorized person seeks access to the secure system, the workstation will authenticate the identity of the camera by asking the camera for the first and second identification numbers. When the query is received by the camera it will initiate the challenge response mechanism to protect the exchange of information between the camera and the workstation. The camera receives the response to the challenge from the workstation and compares the received response with an expected response. If there is a match, then the workstation will be provided the first and second identification numbers.

Referring to FIG. 6, to prevent an unauthorized person from obtaining a possible set of challenges, there is provided another embodiment of the present invention in which an algorithm (71) is installed on the micro controller (32) to implement a timer (33) set to a pre-programmed time (73) during which invalid responses are sent to the workstation. If the micro controller receives an invalid challenge (63) a timer (73) starts and all challenges received during that time period are considered to be invalid. Invalid responses are then sent to the workstation during that time. The time can vary depending on the camera model, camera serial number or camera batch number. In this manner, an unauthorized person will be frustrated in attempting to obtain a set of possible challenges. The process is further explained in Block Diagram #2.

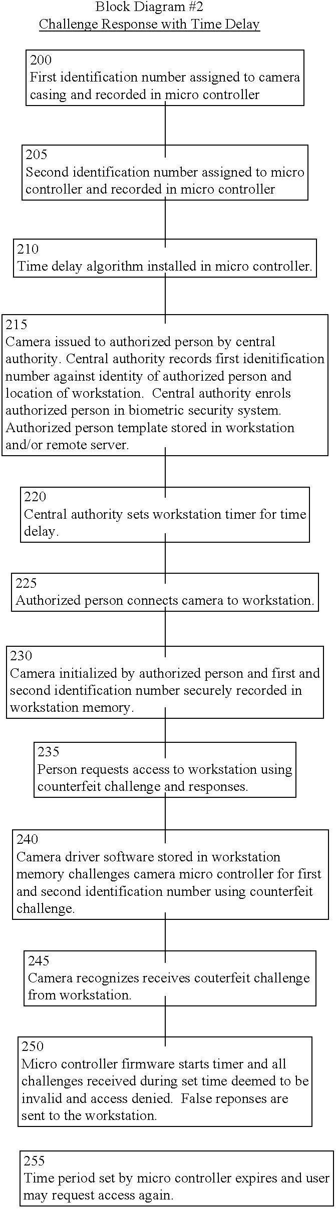

Referring to FIG. 6, to prevent an unauthorized person from obtaining a possible set of response keys there is provided yet another embodiment of the present invention wherein if the workstation receives an invalid response to a challenge, a timer (77) is started by the workstation microprocessor using camera driver software (60) installed on the workstation that disables the device and delays further attempts to gain access. A number of retries may be allowed. The number of retries may be set (79) by the central authority (52). In this way, an impossible amount of time must be expended by the unauthorized person to obtain a possible correct response. This embodiment of the present invention will also prevent attacks whereby an unauthorized person installs a counterfeit device between the camera and the workstation to record the challenge and response exchanges between the two devices.

Since the micro controller has limited processing power, the challenge response algorithm is designed to generate and transmit packets of data no larger than can be successfully handled by the micro controller. Typically this is around 8 bits to favour implementation on an 8 bit micro controller. However, it is understood that using a more powerful micro controller may result in moving larger packets of data. This permits a relatively high degree of transmission security without having to use a more powerful encryption engine.

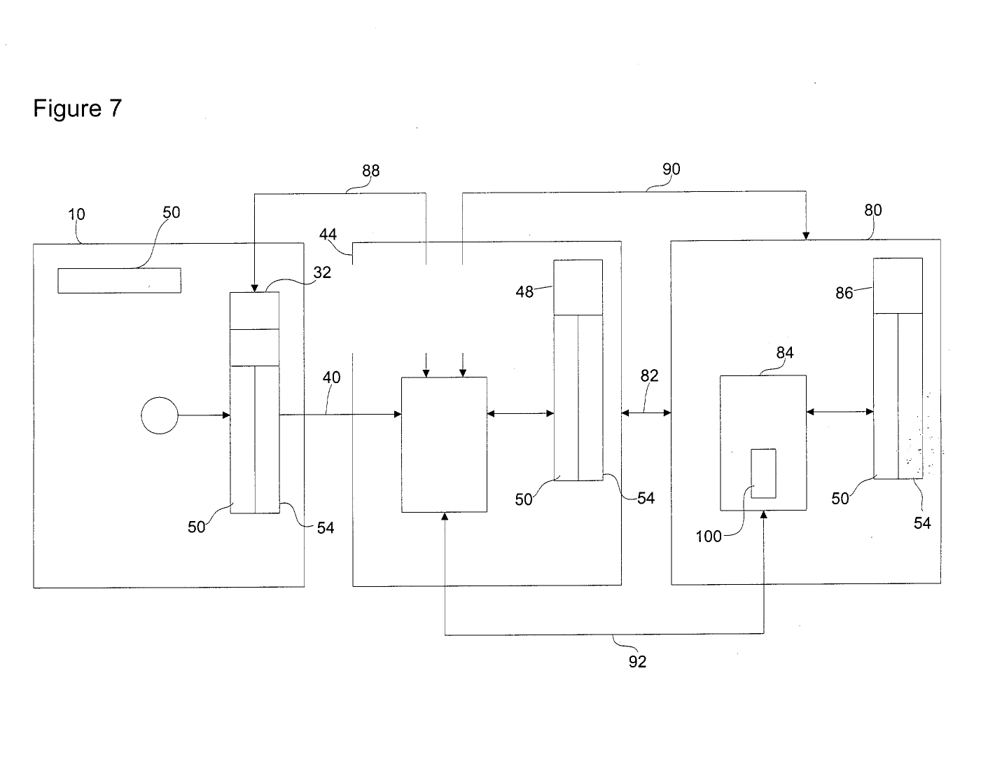

Referring to FIG. 7 there is shown another embodiment of the present invention where access to a remote server is desired. Camera (10) is connected to workstation (44) by way of video output bus (40). Remote server (80) is connected to the workstation (44) by way of bus (82). The remote server includes a central processing unit (84) and a memory (86). In this embodiment of the present invention, during the initialization step the first (50) and second (54) identification means are transmitted to the workstation (44) and stored on the workstation memory (48). Additionally, the first and second identification means are transmitted to the server (80) and stored on the server memory (86). When an authorized person attempts to log on to the network, a challenge response sequence will be initiated as described above between the workstation and the camera. Having the workstation challenge the server provides additional security. The workstation will challenge the server for the first and second identification means (92). The server will respond by transmitting the first and second identification means to the workstation (90). The workstation will attempt a match. If a match exists then server access will be allowed. In addition, a time delay buffer (100) is installed in the microprocessor of the server. In the event that the initial challenge and response between the server and the workstation fails, a timer will be started and all subsequent challenges during that time period will be deemed to be invalid.

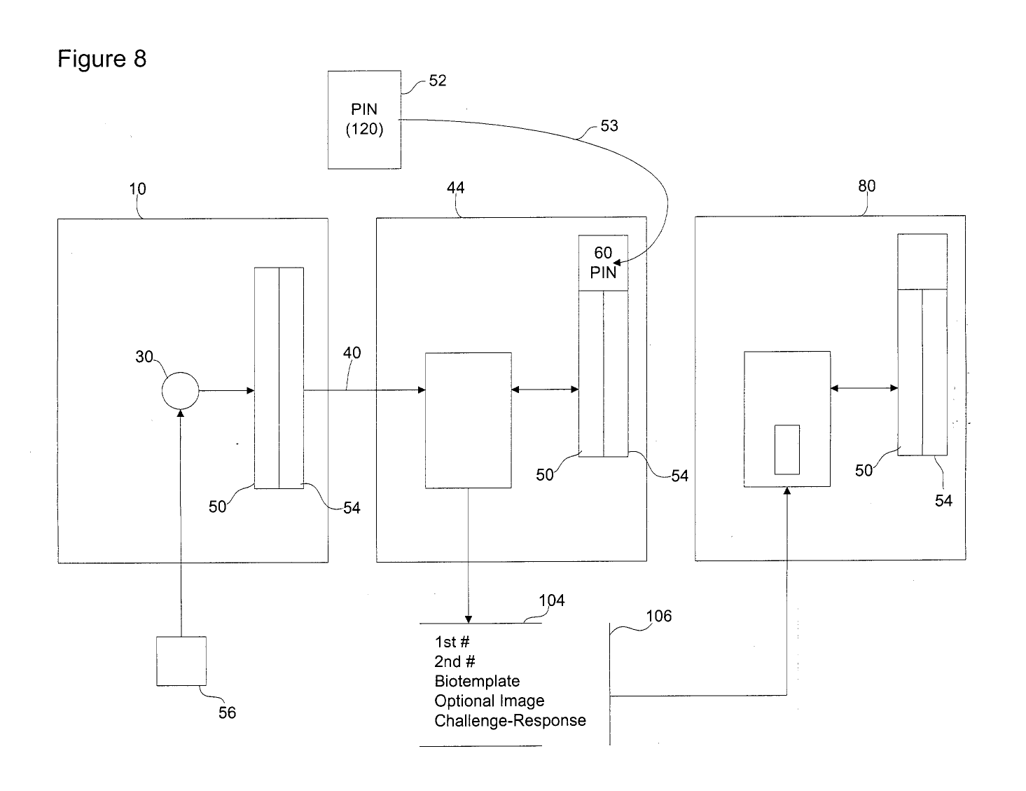

Referring to FIG. 8, there is shown another embodiment of the present invention in which a system of encryption is employed between the workstation (44) and server (80). When the central authority (52) assigns the camera (10) to the authorized user (56), the authorized user is enrolled in the encryption system and assigned a personal identification number (120). The PIN number is encoded (53) into the camera driver software (60) by the central authority. In this way the authorized user does not have to input his or her personal identification number every time access to the restricted system is required. The need for security tokens is also eliminated. In this embodiment of the present invention the authorized user (56) will attempts to log on to the system and gain access to the server (80). The first (50) and second (54) identification numbers recorded in the micro controller are confirmed by the workstation. Before the camera is enabled, a challenge and response cycle will be initiated as described above. Once the challenge and response cycle is successfully completed the camera (10) will be enabled. Image detector (30) captures the image of the authorized user (56) seeking access to the server. The video image will be transmitted to the workstation (44) by way of bus (40). Camera driver software (60) will process the video image and transfer it into a digital biometric template as well as a compressed image of the authorized user. In this embodiment of the present invention, encryption of all transmissions between the workstation and server take place. This creates an effective virtual private network and permits transmission of secure data over a public network. The workstation will send as a data packet (104) the following: the first and second identification numbers, the biometric template, optionally the compressed image and the challenge of the challenge-response cycle. This information will be encrypted (106) by the workstation and then sent to the server as a package. Once received by the server, the package will be decrypted and then processed in the following order:

The first and second identification means will be verified;

The challenge-response cycle will be completed;

The biometric template will be authenticated;

The optional compressed image will be stored on the server memory.

Once these steps have been completed, the authorized user will be allowed access to the server.

Numerous modifications, variations, and adaptations may be made to the particular embodiments of the invention described above without departing from the scope of the invention that is defined in the claims.

What is claimed is:

1. A system for validating the identity of a camera used in a secure access application employing biometrics and attached to a workstation, wherein said camera has a detector, a micro controller and a camera casing and wherein said workstation includes a microprocessor and memory, wherein the system comprises:
a. an authorized person for gaining secure access;
b. a central authority for recording the identity of the authorized person against the identity of the camera;
c. a first identification means for identifying the camera;
d. a second identification means for identifying the micro controller;
e. means for authenticating the identity of the camera attached to the workstation.

2. The system as claimed in claim 1 wherein said first and said second identification means are one of a string of numbers, letters or an alphanumeric string of a predetermined length sufficient to provide a unique identifier.

3. The system as claimed in claim 2 wherein the first identification number is visible to the central authority, permanently etched into the camera casing and recorded in the micro controller.

4. The system as claimed in claim 3 wherein the second identification number is invisible to the authorized person and central authority and permanently recorded in the micro controller.

5. The system as claimed in claim 4 wherein the means for authenticating the identity of the camera consists of a comparison between the first and second numbers stored in the micro controller and the first and second numbers stored in the workstation.

6. The system as claimed in claim 5 further including a challenge-response mechanism that operates between the camera and the workstation.

7. The system as claimed in claim 6 wherein the mechanism is installed on the micro controller during manufacture.

8. The system as claimed in claim 7 wherein the challenge response mechanism comprises the following steps:
a. the workstation queries the camera for the first and second identification numbers;
b. the camera challenges the workstation with the challenge response mechanism;
c. the workstation responds to the camera challenge with a response;
d. the camera compares the received response with an expected response;
e. if there is a match, the camera will permit the workstation to access the first and second identification numbers;

9. The system as claimed in claim 9 further including means to reinitiate the challenge if the first challenge fails.

10. In a system for validating the identity of a camera used in a secure access application employing biometrics and attached to a workstation, wherein said camera has a detector, a micro controller and a camera casing, wherein the system comprises:
a. an authorized user for gaining secure access;
b. a central authority for recording the identity of said camera;
c. a first identification means for identifying the camera;
d. a second identification means for identifying the micro controller;
a method for authenticating the identity of the camera attached to the workstation comprising the following steps:
i. assigning a visible first identification means to a camera casing;
ii. recording said first visible identification means in the micro controller;
iii. assigning a second invisible identification means to a micro controller;
iv. recording said second identification number in the micro controller;
v. issuance by the central authority of an identified camera to an identified authorized user;
vi. recordance by the central authority of the name of the authorized user against the first identification means and the identification and location of the workstation;
vii. biometric enrolment of the authorized person into the secure access system;
viii. connection by the authorized user of the issued camera to the identified workstation; and,
ix. initializing the camera by an initialization method.

11. The method of claim 10 wherein the initialization method comprises the following steps:
a. workstation initiates communication with micro controller;
b. workstation requests first and second identification numbers stored in micro controller;
c. micro controller transmits first and second identification numbers to the workstation;
d. workstation recordal of the first and second identification means in the workstation memory.

12. The system as claimed in claim 1 further comprising means to prevent the compromising of the first and second identification means comprising a delay mechanism embedded in the camera micro controller.

13. The system as claimed in claim 12 wherein the delay mechanism comprises an algorithm programmed into the micro controller firmware to implement a pre-programmed delay in the transmission of response to a challenge.

14. The system as claimed in claim 13 further comprising a mechanism installed on the workstation being able to recognize in invalid response from the micro controller and initiate a time delay inhibiting further attempts to access the system until the time delay is expired.

15. The system as claimed in claim 14 wherein during the time delay invalid responses are sent to the workstation.

16. In a system for validating the identity of a camera used in a secure access application employing biometrics and attached to a workstation, wherein said camera has an image detector, a micro controller and a camera casing and wherein said workstation includes a microprocessor and memory, wherein the system comprises:
a. an authorized person for gaining secure access;
b. a central authority for recording the identity of the authorized person against the identity of the camera;
c. a first identification means for identifying the camera;
d. a second identification means for identifying the micro controller;
e. means for authenticating the identity of the camera attached to the workstation; and,
a method for preventing the compromising of the first and second identification means comprising the following steps:
i. workstation requests first and second identification numbers from the micro controller;
ii. camera issues a challenge to the workstation;
iii. workstation responds to micro controller challenge;
iv. micro controller recognizes response as invalid;
v. micro controller starts timer to run for a predetermined time;
vi. micro controller generates false responses during predetermine time.

17. The method as claimed in claim 17 wherein said method may be reinitiated after the predetermined amount of time has expired.

18. In a system for validating the identity of a camera used in a secure access application employing biometrics and attached to a workstation, wherein said camera has an image detector, a micro controller and a camera casing and wherein said workstation includes a microprocessor and memory, wherein the system comprises:
a. an authorized person for gaining secure access;
b. a central authority for recording the identity of the authorized person against the identity of the camera;
c. a first identification number for identifying the camera;
d. a second identification number for identifying the micro controller;
e. means for authenticating the identity of the camera attached to the workstation; and,
f. means to prevent the compromising of the first and second numbers means wherein said means comprises a timer embedded in the camera driver software installed on the workstation;
a method for preventing the compromising of the first and second identification means comprising the following steps:
i. request secure access to workstation;
ii. workstation issues challenge to micro controller;
iii. micro controller recognizes challenge as valid;
iv. micro controller issues an invalid response to the workstation;
v. workstation recognizes the response as invalid;
vi. camera driver software starts a timer to run for a predetermined time during which responses to challenges are faked.

19. A system for validating the identity of a camera used in a secure access application employing biometrics and attached to a workstation, wherein said camera has an image detector, a micro controller and a camera casing and wherein said workstation includes a microprocessor and memory, and wherein the workstation is attached to a remote server; the system comprising:
a. an authorized person for gaining secure access;
b. a central authority for recording the identity of the authorized person against the identity of the camera;
c. a first identification means for identifying the camera;
d. a second identification means for identifying the micro controller;
e. means for authenticating the identity of the camera attached to the server; and,
f. means for encryption of transmissions between the workstation and server.

20. The system as claimed in claim 20 wherein said encryption means between the workstation and the server comprises a first layer of encryption and a second layer of encryption.

21. The system as claimed in claim 21 wherein said first layer of encryption encrypts the first and second identification means transmitted between the workstation and server.

22. The system as claimed in claim 22 wherein the second layer of encryption encrypts the following data between the workstation and the server:
a. first layer encrypted first identification number;
b. first layer encrypted second identification number;
c. challenge issued by the micro controller; and,
d. biometric data.
